(19) United States
(12) Patent Application Publication
(10) Pub. No.: US 2008/0170662 A1
(43) Pub. Date: Jul. 17, 2008

(54) Apparatus for X-ray laminography and/or tomosynthesis

(76) Inventor: Alfred Reinhold, Wunstorf (DE)

Correspondence Address: SHLESINGER, ARKWRIGHT & GARVEY LLP, 1420 KING STREET, SUITE 600, ALEXANDRIA, VA, 22314, US

(21) Appl. No.: 11/987,550

(22) Filed: Nov. 30, 2007

Related U.S. Application Data
(63) Continuation of application No. PCT/EP2006/005167, filed on May 31, 2006.

(30) Foreign Application Priority Data
Jun. 8, 2005 (DE) 10 2005 026 578.2

(51) Int. Cl. G01N 23/04

(52) U.S. Cl. 378/62

(57) ABSTRACT

X-ray laminography and/or tomosynthesis apparatus includes a stationary X-ray tube with an X-ray source for generating X-rays for radiographic scanning of an object that is to be examined. The apparatus includes a stationary fixture for the object that is to be examined, and the stationary fixture being arranged in a stationary manner during a radiographic session. A stationary X-ray detector is provided for detecting the X-rays once the object which is to be examined has been radiographed. The X-ray detector is provided with a substantially planar detection surface whose dimensions are selected, taking into account the distance from the X-ray source to the object which is to be examined and the distance from the object which is to be detected to the X-ray detector, such that during scanning the X-rays always impinge the detection surface after radiographing the object.

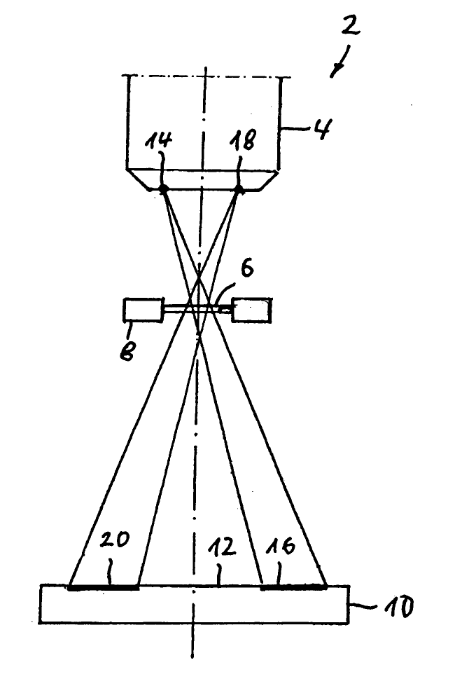

### CROSS-REFERENCE TO RELATED APPLICATIONS

This application is a continuation application of International PCT application No. PCT/EP2006/005167, filed May 31, 2006, which claims the priority of German application No. 10 2005 026 578.2, filed Jun. 8, 2005, and each of which is incorporated herein by reference.

### FIELD OF THE INVENTION

The invention relates to an apparatus for X-ray laminography and/or X-ray tomosynthesis. The invention further relates to an apparatus for X-ray laminography and/or X-ray tomosynthesis with a stationary X-ray tube with an X-ray source for generating X-ray radiation for radiographic scanning of an object to be examined.

### BACKGROUND OF THE INVENTION

Such apparatuses are generally known and are used, e.g., to examine electronic components, printed circuit modules, or printed circuits.

X-ray laminography processes or X-ray tomosynthesis processes require, in principle, a movement of an X-ray beam of an X-ray source relative to an object to be examined. Technical details of X-ray laminography processes or X-ray tomosynthesis processes are generally known to a person having ordinary skill in the art, e.g., from DE 103 08 529 A1, and are therefore not explained in detail here.

DE 103 08 529 A1 teaches an apparatus for X-ray laminography or X-ray tomosynthesis that includes an X-ray source for generating X-ray radiation for a scanning radiograph of an object to be examined and includes a holder for the object to be examined. This known apparatus furthermore includes an X-ray detector for detecting the X-ray radiation after radiographing the object to be examined. In the case of this known apparatus the object to be examined is held stationary in its holder during the examination whereas in order to carry out the laminography process or the tomosynthesis process the X-ray tube, as well as the X-ray detector, is moved relative to the object. Similar apparatuses are also known from EP 0 683 389 A1, DE 101 42 159 A1, DE 102 42 610 A1, DE 199 51 793 A1, DE 103 17 384 A1 and DE 103 09 887 A1.

A disadvantage of these known apparatuses is that due to the required movement of the X-ray source as well as of the X-ray detector relative to the object to be examined, significant masses must be moved, which requires a significant mechanical complexity and therefore makes the known apparatuses complex and expensive to manufacture. This disadvantage is intensified even more by the fact that the movement of masses in order achieve a sufficient image quality must take place synchronously with high precision and relate to the movement of the X-ray source on the one hand and to the movement of the detector on the other hand.

In a modification of the previously cited apparatuses it has already been suggested to use several stationary X-ray detectors instead of a movable X-ray detector. However, in such a corresponding apparatus a movement of the X-ray tube continues to be necessary, to that in principle the above-described disadvantages remain.

Furthermore, apparatuses for X-ray laminography or X-ray tomosynthesis have already been suggested in which the X-ray source is arranged in a stationary manner and the object to be examined and the X-ray detector are moved. Even these known apparatuses have the disadvantage in principle that significant masses have to be moved.

DE 196 04 802 A1 teaches an apparatus for X-ray laminography or X-ray tomosynthesis in which an X-ray source and an X-ray detector are arranged in a stationary manner whereas a holder for the object to be examined is moved during the examination. Similar apparatuses are also known from DE 197 23 074, U.S. Pat. No. 6,748,046 B2, DE 37 903 88 T1 and DE 102 38 579 A1.

Furthermore, apparatuses for X-ray laminography or X-ray tomosynthesis are known, e.g., from DE 103 38 742 A1, in which a stationary X-ray tube with an X-ray source which is movable inside the X-ray tube, a stationary holder for the object to be examined and a stationary X-ray detector are used; and, in order to achieve the necessary spatial resolution, a movable mirror system is used that guides the X-ray radiation after passing through the object to be examined in accordance with the particular position of the X-ray beam onto the X-ray detector. A similar apparatus is also known from WO 89/04477.

Even those apparatuses have the disadvantage that significant masses still have to be moved with high precision. In addition, the necessary mirror system requires significant mechanical complexity and increases the expense of manufacturing these known apparatuses.

Furthermore, an apparatus of this type for X-ray laminography and/or X-ray tomosynthesis is known that includes a stationary X-ray tube with an X-ray source for generating X-ray radiation for scanning an object to be examined, includes a holder for the object to be examined, that is arranged in a stationary manner during a radiographing sequence, and includes a stationary X-ray detector for detecting the X-ray radiation after the radiographing of the object to be examined. In these known apparatuses, on account of its internal vacuum, the X-ray detector is designed as a large-surface image intensifier that includes a front glass disk with a large outward curvature. This known apparatus avoids to a great extent a mechanical movement of rather large masses but has the disadvantage that the evaluation of the images recorded with it is very time-consuming.

### OBJECTS AND SUMMARY OF THE INVENTION

An object of the invention is to provide an apparatus for X-ray laminography and/or X-ray tomosynthesis in which the X-ray tube as well as the holder for the object to be examined and the X-ray detector are arranged in a stationary manner and therefore a mechanical movement of rather large masses is avoided and the evaluation of the recorded images is readily and rapidly possible.

This object is achieved in a surprisingly simple manner in that the X-ray detector according to the invention includes a substantially planar detection surface and that the dimensions of the detection surface are selected so that, taking into account the distance from the X-ray source to the object and the distance from the object to the X-ray detector, during the scanning the X-rays always impinge on the detection surface after having passed through the object. The invention is based on the recognition that the evaluation of the recorded images can thus be substantially simplified and formed in a time-saving manner; and, that instead of a detector with a strongly curved front glass disk, an X-ray detector with a substantially planar detection surface can be used. In this manner, distortions of the recorded images, that must be compensated for in an evaluation with a large amount of time and computation, are largely avoided. As a consequence, the evaluation of the recorded images is significantly simplified and achieves substantial time-savings. In addition, simpler algorithms can be used to evaluate the images and, as a result, the image quality is improved relative to the known apparatuses.

Since in the apparatus in accordance with the invention the X-ray tube, as well as the holder for the object to be examined, and the X-ray detector are arranged in a stationary manner, it is possible to carry out an X-ray laminography process or an X-ray tomosynthesis process without rather large masses having to be moved. All that is required is a movement of the X-ray source inside the X-ray tube for scanning the object to be examined. However, the masses to be moved here are negligibly small so that in comparison to the known systems, in which the X-ray tube itself is moved, in this manner the mechanical complexity for realizing the apparatus of the invention is significantly reduced.

According to the invention, a substantially planar detection surface means a detection surface whose curvature, if any, is so small that this curvature causes no noticeable distortions in the recorded images.

According to the invention, a radiography sequence means a process of radiographing a spatially delimited part to be examined of the object to be examined. It is possible according to the invention to move the holder into a new position after a radiography sequence and prior to the start of a new radiography sequence in order to move another object or another part of the already previously examined object into the image and examine it. According to the invention it is essential that the holder remain stationary during the radiography sequence, that is, during the time of the taking of an X-ray.

According to the invention, scanning means a movement of the X-ray beam relative to the object to be examined in order to carry out a laminography process or tomosynthesis process, independently of whether the X-ray beam is moved in a rectilinear, linear, meandering, circular, or helical manner, or in some other manner relative to the object to be examined.

According to the invention, detection surface means a surface formed by sensors sensitive to the X-ray radiation.

An extremely advantageous further embodiment of the teaching of the invention provides that the detection surface is formed by a two-dimensional array of X-ray-sensitive detection elements. Such arrays are available as standard components and make possible the detection of X-ray radiation with a high degree of sensitivity.

A further embodiment of the embodiment set forth above provides that the X-ray-sensitive detection elements are formed by photodiodes; e.g., include photodiodes. Such photodiodes make the detection of X-ray radiation possible with a high degree of sensitivity.

An exemplary embodiment of an apparatus in accordance with the invention is explained in detail in the following using the attached, schematized drawing, whose sole FIGURE shows a sketch of a lateral view of an apparatus in accordance with the invention.

Relative terms, such as left, right, up, and down are for convenience only and are not intended to be limiting.

### BRIEF DESCRIPTION OF THE DRAWINGS

The drawing shows an embodiment of an apparatus in accordance with the invention for X-ray laminography and/or X-ray tomosynthesis.

### DETAILED DESCRIPTION OF THE INVENTION

An apparatus 2 in accordance with the invention for X-ray laminography and/or X-ray tomosynthesis is shown in the drawing and includes a stationary X-ray tube 4 with an X-ray source arranged so that it can move in the inside of the X-ray tube for generating X-ray radiation for a scanning radiograph of the object to be examined 6. The X-ray source is movably arranged in the inside of X-ray tube 4 for scanning radiographing of object 6 to be examined.

Apparatus 2 furthermore includes a holder 8 on which or in which object 6 to be examined, e.g., an electronic printed card, is held stationary during a radiography sequence when carrying out the laminography process or the tomosynthesis process. After the end of a radiography sequence, holder 8 can be moved into a new position in order to move another part of the previously examined object into the image and examine it. Furthermore, apparatus 2 in accordance with the invention includes a stationary X-ray detector 10 for detecting the X-ray radiation after a radiographing of object 6 to be examined. According to the invention the X-ray detector includes a substantially planar detection surface 12 that is formed in this exemplary embodiment by a two-dimensional array of X-ray-sensitive elements in the form of photodiodes, which array extends in the plane of the drawing or parallel to the plane of the drawing and vertical to the latter. According to the invention the dimensions of detection surface 12 are selected in such a manner, taking into consideration the distance of the X-ray source from object 6 and the distance of object 6 to X-ray detector 10, that the X-ray beams always impinge detection surface 12 during the scanning after having passed through object 6.

In the drawing reference numeral 14 indicates a first position during the scanning whereas reference 16 indicates the projection of the X-ray beam on detection surface 12 after having passed through object 6 that results in this position of the X-ray source. In contrast thereto, in the drawing reference number 18 indicates a second position of the X-ray source during the scanning of object 6 whereas reference 20 indicates a projection of the X-ray radiation on detection surface 12 after having passed through object 6 that results in this position of the X-ray source. According to the invention the dimensions of the detection surface are therefore selected in such a manner in the drawing in the plane of the drawing and vertical to it so that the X-ray radiation always impinges on the detection surface during the scanning, that can take place in any suitable manner, e.g., in a rectilinear, meandering, helical manner or in any other manner, after having passed through object 6.

The method of operation of apparatus 2 in accordance with the invention is as follows;

In order to carry out an X-ray laminography process or X-ray tomosynthesis process the object held stationary by holder 8 is scanned during an appropriate movement of the X-ray source inside X-ray tube 4, during which the X-ray radiation impinges planar detection surface 12 of X-ray detector 10 after having passed through object 6. Resulting output signals of the photodiodes forming detection surface 12 are conducted to an evaluation apparatus (not shown) that evaluates the output signals and generates, e.g., a layered image of object 6 from them that can be displayed on a display apparatus, e.g., a monitor (not shown). The manner of the evaluation of the output signals of the photodiodes and of the conversion of these output signals into a layered image is generally known to an expert in the art and is therefore not explained in detail here.

As a result of the fact that detection surface 12 is designed essentially planar in accordance with the invention, distortions of the images produced are avoided to a great extent so that the evaluation of the output signals of the photodiodes can be carried out with simpler algorithms. In contrast to apparatuses of the type concerned and known from the state of the art a significant speed advantage in the evaluation results from the fact that a compensation of distortions caused by non-planar detection surfaces is not necessary.

As a result of the fact that X-ray tube 4 as well as object 6 to be examined and X-ray detector 10 are stationary during the examination, apparatus 2 in accordance with the invention has only very small moved masses. It is therefore relatively simple and economical to manufacture.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

I claim:

1. An apparatus for X-ray laminography and/or X-ray tomosynthesis, comprising:
a stationary X-ray tube with an X-ray source for generating X-ray radiation for a scanning radiographing of an object to be examined;
a holder for the object to be examined, said holder being stationary during a radiographic sequence;
a stationary X-ray detector for detecting the X-ray radiation after it passes through the object to be examined,
said X-ray detector has a substantially planar detection surface; and
dimensions of said detection surface are selected in such a manner, taking into consideration the distance of said X-ray source to the object to be examined and the distance of the object to be examined to said X-ray detector, that during scanning the X-rays always impinge on said detection surface after having passed through the object.

2. The apparatus according to claim 1, wherein said detection surface is formed by a two-dimensional array of X-ray-sensitive detection elements.

3. The apparatus according to claim 2, wherein said X-ray-sensitive direction elements are formed by photodiodes.
